(19) United States
(12) Patent Application Publication
(10) Pub. No.: US 2015/0348418 A1
(43) Pub. Date: Dec. 3, 2015

(54) Driver Assistance System and Method for Assisting the Driver of a Motor Vehicle When Leaving a Determined Lane

(71) Applicant: Bayerische Motoren Werke Aktiengesellschaft, Muenchen (DE)

(72) Inventors: Andreas PFEIFFER, Holzkirchen (DE); Thomas BURTSCHE, Warngau (DE)

(21) Appl. No.: 14/825,736

(22) Filed: Aug. 13, 2015

Related U.S. Application Data
(63) Continuation of application No. PCT/EP2014/054224, filed on Mar. 5, 2014.

(30) Foreign Application Priority Data
Mar. 6, 2013 (DE) 10 2013 203 819.4

(51) Int. Cl. G08G 1/16; B60Q 9/00

(52) U.S. Cl. CPC G08G 1/167; B60Q 9/008

(57) ABSTRACT

In a driver assistance system for assisting a driver of a motor vehicle when leaving a determined lane by use of a lane departure warning system, which is connected to at least one lane detection unit and to a warning and/or transversal guidance unit, the lane departure warning system executes a warning and/or a transversal guidance intervention, if the motor vehicle moves too close to a defined boundary of the lane. The lane departure warning system records and uses information about a defined driving situation of the pertaining motor vehicle such that a currently determined lane may be changed by shifting at least one defined boundary depending on the driving situation.

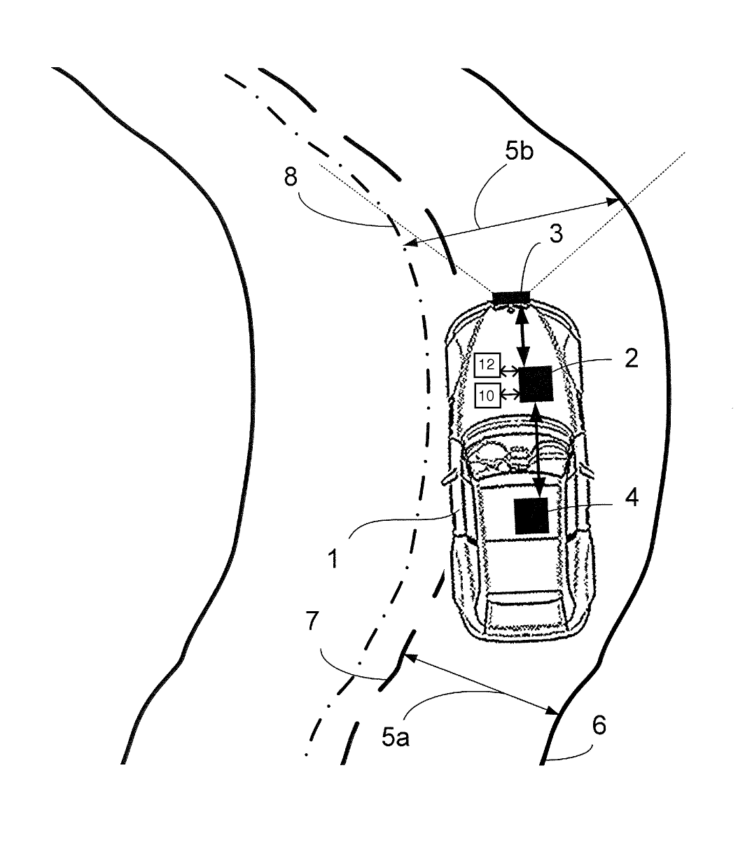

### CROSS REFERENCE TO RELATED APPLICATIONS

This application is a continuation of PCT International Application No. PCT/EP2014/054224, filed Mar. 5, 2014, which claims priority under 35 U.S.C. §119 from German Patent Application No. 10 2013 203 819.4, filed Mar. 6, 2013, the entire disclosures of which are herein expressly incorporated by reference.

### BACKGROUND AND SUMMARY OF THE INVENTION

The invention relates to a driver assistance system and method for assisting the driver of a motor vehicle when leaving a predetermined lane.

There are a great number of known warning and/or transverse-guiding driver assistance systems, in particular so-called lane departure prevention systems (also often referred to as “Heading Control” or “Lane Departure Warning”), which detect their own “track”, hereinafter referred to as lane, in particular with the aid of road markings and issue optical, acoustic or haptic warnings to the driver when the vehicle leaves its own (“normal”) lane.

A transverse-guiding driver assistance system with counter-steering intervention, in addition to the haptic warning, to align the vehicle in the direction of the center of the lane is known, for example, from DE 10 2005 036 219 A1. This causes a lane departure prevention device for assisting the driver of a motor vehicle to generate a haptic warning in the form of a steering wheel vibration and always, simultaneously with said warning as a driver assist reaction, an automatic counter-steering back to the center of the lane if the motor vehicle involuntarily leaves a predetermined lane and makes contact with or approaches an edge of its own lane.

A counter-steering occurs, for example, by applying a steering torque to the steering wheel by way of a steering motor, and optionally a steering gear connected to the steering wheel rod, or by an input from an electric power steering system. A “counter-steering” means a return, in particular, to the center of the previously used lane, which is recognizable by the lane detection unit, usually by evaluating the course of road markings and/or road boundaries. However, the lane detection unit may also detect lanes by other means, for example by detection and analysis of guardrails or roadsides.

In doing so, the applied steering torque must be such that the driver can override an automatic counter-steering at any time. However, such counter-steering units are already generally known.

The object of the invention is to improve a driver assistance system with a lane departure prevention device in such a way that the driver is safely guided, but not bothered by unnecessary interventions and warnings.

This and other objects are achieved by a driver assistance system according to the invention for assisting the driver of a motor vehicle when leaving a predetermined lane. The driver assistance system has a lane departure prevention device that is connected to at least one lane detection unit and to a warning and/or transversal guidance unit. The lane departure prevention device executes a warning and/or a transversal guidance intervention if the motor vehicle moves too close to a defined boundary of the lane. The lane departure prevention device records and processes information about a defined driving situation of the own motor vehicle in such a fashion that a currently predetermined lane may be changed by shifting at least one defined boundary, depending on the driving situation.

Preferably, the lane departure prevention device is also connected to a navigation system. The lane departure prevention device applies information from the navigation system regarding the type and the course of the road so that the boundaries can be adaptively changed with respect to the lane markings and/or roadway shoulders where the driver assistance system issues a warning and/or leads to the center of the lane.

Information about a defined driving situation may include not only the type of road or the course of the road, but also the type of driver or a preset driving behavior. In principle, this allows for a virtual lane widening on winding roads and/or in sporty driver- or vehicle behavior. Upon detection of an imminent collision risk (e.g. oncoming traffic detection), the currently defined (possibly widened) lane may (again) be restricted.

The invention is based on the following findings. A constant tracking via steering torques, as is known from the aforementioned prior art, changes the feel of the steering and is not desired by some drivers. An optical, acoustic or haptic warning during lane departure increases the attention, but the driver must be permitted to execute an optimally quick and meaningful correction himself. Features of a driver assistance system with a lane departure prevention device provide a warning when leaving the lane, and/or always guide the vehicle back toward the center of the lane. These features recognize the lane, for example by means of a camera, by lane markings and/or roadway shoulders.

In particular, this rigid directing toward the center of the lane does not always correspond to the wishes of a driver. In particular, a driver's driving differs depending on the type of road (for example, winding country road, or straight restricted access highway (Autobahn)). In such cases, it is quite possible that the limits with respect to the lane markings and/or roadway shoulders at which the driver assistance system issues a warning and/or directs the vehicle toward the center of the lane, do not match the driver's respective driving style, depending on the type of road. This could reduce the acceptance of the system.

According to the invention, the navigation system that is coupled with the transversal driver assistance system is, in particular, a navigational system that receives input regarding the type of road and/or the course of the road. The information about the type of road and/or the course of the road is evaluated such that it is associated with different system intervention parameters. Warning thresholds and/or predetermined ideal driving lines are adapted to the respective system intervention parameters. It may be preferable, in addition to the information on the type of road and/or the course of the road, to take collision risk data from obstacle detecting sensors into account.

By adapting itself to a given situation, the invention therefore prevents annoying interventions of the driver assistance system.

Other objects, advantages and novel features of the present invention will become apparent from the following detailed description of one or more preferred embodiments when considered in conjunction with the accompanying drawing.

### BRIEF DESCRIPTION OF THE DRAWING

The sole FIGURE is a schematic illustration of an embodiment of the invention.

### DETAILED DESCRIPTION OF THE DRAWINGS

Referring to the FIGURE, it shows a vehicle 1 with a driver assistance system for assisting the driver when leaving a predetermined lane 5a or 5b with a lane departure prevention device 2 that is connected to at least one lane detection unit 3 (for example a frontal-mounted camera), and a known warning and/or transversal guidance unit 10.

In this example, the vehicle 1 moves beyond the centerline 7, which here is also the left boundary of the “normal” lane 5a. Lane 5a is defined by two boundaries: the centerline 7 of the road at the left, and the shoulder 6 of the road at the right. These boundaries would, according to the prior art, represent warning- or intervention thresholds. On a straight restricted access highway (Autobahn), this may be acceptable to the driver. However, in the example shown, the vehicle is traveling on a winding country road, where experience has shown that at least sporty drivers do not wish to strictly keep to the centerline of the road. This situation calls for a different system intervention than the aforementioned example of a straight restricted access highway (Autobahn).

According to the invention, the lane departure prevention device 2 is therefore linked to a navigation system 4 here. The lane departure prevention device 2 evaluates information from the navigation system 4 regarding the road type and/or the course of the road in such a fashion that the boundaries with respect to the lane markings and/or roadway shoulders where the driver assistance system issues a warning and/or directs the vehicle to the center of the lane can be modified by adaptation. The navigation system 4 therefore allows setting different system interference conditions. Preferably, the lane departure prevention device 2 is also connected to an obstacle-detecting sensor unit 12 for detecting risks of collision, such as passing vehicles and/or oncoming traffic. Such systems are as such already known and therefore not shown here in further detail.

In the example shown, prior art would dictate system interference under conditions such as driving over the centerline 7 of the road, respectively the left boundary 7 of lane 5a, on a winding country road in the absence of oncoming traffic and without passing. According to the invention, in the aforementioned driving situation, a virtually widened lane 5b with a left boundary 8 located left of the centerline 7 represents the new system intervention parameters.

In straight restricted access highway (Autobahn) driving, or on a winding country road when oncoming traffic has been detected, it is preferred, according to the invention, to specify the “normal” lane 5a; accordingly, the widened lane 5b would be maintained on a winding country road without oncoming traffic until oncoming traffic or another collision risk is detected.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A driver assistance system for assisting a driver of a motor vehicle when leaving a predetermined lane, the driver assistance system comprising:
a lane departure prevention device equipped with at least one lane detection unit and a warning and/or transversal control unit, wherein
the lane departure prevention device performs a warning and/or a transverse intervention when the motor vehicle is too close to a defined boundary of the predetermined lane,
the lane departure prevention device captures information about a defined driving situation of the motor vehicle, and
the lane departure prevention device utilizes the captured information about the defined driving situation such that a currently predetermined lane is changed depending on the defined driving situation by shifting the defined boundary of the predetermined lane depending on the driving situation.

2. The driver assistance system according to claim 1, further comprising:
a navigation system providing information about the defined driving situation, an actual type of road being traveled on, and/or a course of the road, wherein
the lane departure prevention device processes the information so as to allow driving on a relatively winding road according to an ideal trajectory by changing the currently predetermined lane to a widened lane which is widened on an inside of a curve relative to the currently predetermined lane.

3. The driver assistance system according to claim 2, wherein the lane departure prevention device processes the information such that the currently predetermined lane is used for warning and/or transverse intervention on relatively straight roads.

4. The driver assistance system according to claim 1, wherein the information about the defined driving situation, a type of driver, and/or a currently set vehicle driving mode is processed such that for a relatively sporty type of driver or a sporty drive mode, a wider lane will be provided verses the currently predetermined lane that would be specified for the type of driver or the drive mode providing a more comfortable drive or better fuel efficiency.

5. The driver assistance system according to claim 1, further comprising:
an obstacle detection sensor that provides data concerning a collision risk generated by other road users, wherein
the lane departure prevention device takes the data into account when changing the currently predetermined lane and, if required, limits the currently predetermined lane to the own drivers lane.

6. A method of operating a lane departure prevention device equipped with at least one lane detection unit and a warning and/or transversal control unit, the method comprising the acts of:
determining a currently predetermined lane of a vehicle via the lane detection unit;
obtaining information about a defined driving situation of the vehicle;
using the obtained information about the defined driving situation of the vehicle to shift at least one defined boundary of the currently predetermined lane based upon the defined driving situation.

7. The method according to claim 6, wherein the shifting of the at least one defined boundary is carried out to widen the currently predetermined lane for use by the lane departure prevention device.

8. The method according to claim 7, wherein when the defined driving situation indicates a relatively winding road is being driven upon, the currently predetermined lane is widened on an inside of a curve relative to the currently predetermined lane.

9. The method according to claim 8, further comprising the acts of:
obtaining information concerning a collision risk generated by other road users; and
preventing the widening of the currently predetermined lane to minimize a collision risk based on the obtained information.
